(19) United States
(12) Patent Application Publication
(10) Pub. No.: US 2026/0295952 A1
(43) Pub. Date: Oct. 1, 2026

(54) METHOD OF PRODUCING A REINFORCING BAR

(71) Applicant: NAKAGAWA SANGYO CO, LTD., Inuyama-shi (JP)

(72) Inventors: Hiroshige NAKAGAWA, Inuyama-shi (JP); Noriaki NAKAGAWA, Inuyama-Shi (JP)

(21) Appl. No.: 19/177,758

(22) Filed: Apr. 14, 2025

Related U.S. Application Data
(62) Division of application No. 17/464,996, filed on Sep. 2, 2021, now abandoned.

(30) Foreign Application Priority Data
Sep. 4, 2020 (JP) 2020-148625

(51) Int. Cl. B29C 70/52; B29C 48/154; B29C 70/20; B29K 23/00; B29K 223/00; B29K 309/00; B29L 31/00

(52) U.S. Cl. CPC B29C 70/52; B29C 48/154; B29C 70/20; B29K 2023/12; B29K 2223/06; B29K 2223/12; B29K 2309/00; B29L 2031/001

(57) ABSTRACT

A method of producing a reinforcing bar (rebar) includes: arranging one or more thermoplastic polymer fibers (2) in a central portion of a cross-section; arranging a plurality of non-metallic reinforcing fibers (1) on an outer periphery of the thermoplastic polymer fiber(s) (2); heating the thermoplastic polymer fiber(s) (2) to its (their) melting temperature or higher to melt the thermoplastic polymer fiber(s) (2); and cooling the melted thermoplastic polymer to form a bar-shaped polymer layer (91) in the central portion of the cross-section and a fiber-reinforced polymer layer (92) on an outer periphery of the bar-shaped polymer layer (91).

### CROSS-REFERENCE

The present application claims priority to Japanese patent application no. 2020-148625 filed on Sep. 4, 2020, the contents of which are incorporated herein by reference.

### TECHNICAL FIELD

The present invention relates to techniques for producing a reinforcing bar (“rebar”) that may be suitably used for reinforcement of concrete or other materials.

### RELATED ART

As such a kind of reinforcing bar, a reinforcing bar employing basalt fibers that does not rust and enables the strength of concrete to be maintained for an extended period of time is gaining attention as a replacement for conventional reinforcing bars made of iron. As disclosed in Japanese Patent Laid-Open No. 2012-251378, for example, a reinforcing bar having a structure obtained by covering the circumference of a core material, which is a bundle of basalt fibers, with a thermoplastic resin layer having a predetermined thickness has been proposed as such a reinforcing bar. As a conventional method for forming the resin layer around the core material, a dipping method has been widely used in which the core material is immersed in a molten resin solution. On the other hand, as disclosed in International Publication No. WO 2017/043654, an attempt has been made which involves forming the core material with a resin bar having a predetermined diameter and winding a reinforcing fiber around the core material, to increase strength.

### SUMMARY OF THE INVENTION

However, the above-mentioned dipping method involves the problems of requiring a large manufacturing apparatus and high production costs, due for the necessity of providing a storage tank for the molten resin solution and the like. On the other hand, the above-mentioned method of providing the resin bar as the core material in advance also involves the problem of requiring the resin bar to be additionally produced, e.g., by extrusion molding or the like.

It is therefore one non-limiting object of the present teachings to disclose techniques for producing a reinforcing bar that enables the production of a reinforcing bar having sufficient strength in a convenient and inexpensive manner.

In a first aspect of the present teachings, a method of producing a reinforcing bar (rebar) includes: arranging at least one thermoplastic resin (polymer) fiber (2) in a central portion of a cross-section; arranging at least one reinforcing fiber (1), preferably non-metallic fiber(s), on an outer periphery of the at least one thermoplastic resin (polymer) fiber (2); heating the at least one thermoplastic resin (polymer) fiber (2) to its melting temperature or higher to melt the at least one thermoplastic (polymer) fiber (2) ; and cooling the melted thermoplastic resin (polymer) to form a bar-shaped (rod-shaped) (polymer) core (layer) (91) in the central portion of the cross-section and a fiber-reinforced resin layer (92) on (surrounding) an outer periphery of the resin (polymer) core (91). Preferably, a plurality of the reinforcing fibers (1) circumferentially surround the resin (polymer) core (91) such that the reinforcing fibers (1) extend longitudinally in parallel to the longitudinal direction of the resin (polymer) core (91).

In a reinforcing bar produced by such a method, the bar-shaped resin (polymer) core is formed in the central portion of the cross-section, and the fiber-reinforced resin layer, in which the at least one reinforcing fiber is embedded in a solid resin (polymer), is formed on an outer periphery of the resin (polymer) core, preferably circumferentially surrounding the resin (polymer) core, thereby forming a reinforcing bar having sufficient strength owing to the firm bonding between the bar-shaped resin (polymer) core and the fiber-reinforced resin (polymer) layer. In addition, such a method simplifies the configuration of the manufacturing apparatus by eliminating the necessity of providing a storage tank for a molten resin (polymer) solution, which is required in conventional dipping methods, and reduces manufacturing effort by eliminating the necessity of providing (manufacturing) a resin bar as a core material in advance by extrusion molding or the like, leading to a significant reduction of manufacturing costs overall.

In a second aspect of the present teachings, a resin (polymer) covering layer (101) is further formed on (preferably, surrounding) an outer periphery of the fiber-reinforced resin (polymer) layer (92).

In such an embodiment, the strength of such a reinforcing bar can be further increased and/or chemical resistance can be improved, due to the covering layer formed on the outer periphery.

In a third aspect of the present teachings, basalt fiber may be the at least one reinforcing fiber (1).

Such a reinforcing bar may be effectively used as a reinforcing bar to be installed, e.g., inside concrete.

Note that the above numerals in parentheses indicate, for referential purpose, correspondence relationships with specific features described in the embodiments below and should not be interpreted as limiting or affecting the scope of the claims.

As described in the foregoing, techniques for producing a reinforcing bar according to the present teachings enable the production of a reinforcing bar having sufficient strength in a convenient and inexpensive manner.

### BRIEF DESCRIPTION OF THE DRAWINGS

FIG. 1 is a schematic perspective view of an apparatus for carrying out a method of producing a reinforcing bar according to a first embodiment of the present teachings;

FIG. 2 is a notional cross-sectional view of the reinforcing bar;

FIG. 3 is a schematic lateral view of the apparatus for carrying out a method of producing a reinforcing bar according to the second embodiment of the present teachings; and

FIG. 4 is a notional cross-sectional view of the reinforcing bar formed by the apparatus of FIG. 3.

### DETAILED DESCRIPTION OF THE PREFERRED EMBODIMENTS

It is noted that the embodiments described below are merely examples, and various design improvements made by one of ordinary skill in the art without departing from the spirit of the present invention are also encompassed in the scope of the present invention.

### First Embodiment

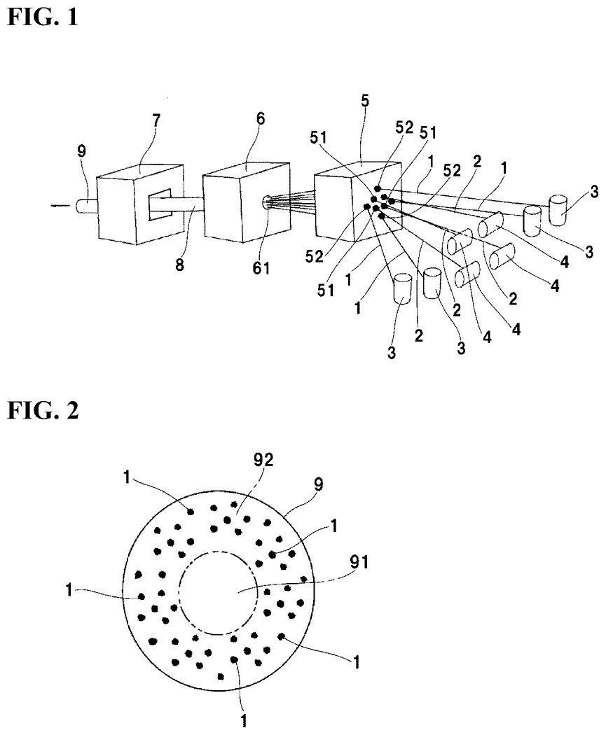

FIG. 1 shows an example of a configuration of an apparatus for carrying out a method of producing an embodiment of a reinforcing bar according to the present teachings. In FIG. 1, basalt fibers 1, as the reinforcing fibers, are wound around respective bobbins 3, and polypropylene (PP) fibers 2, as the thermoplastic resin (polymer) fibers that will ultimately serve as a matrix resin (polymer), are wound around respective bobbins 4. The bobbins 3, 4 are rotatably supported by one or more racks (not illustrated).

The basalt fibers 1 and the PP fibers 2, which are respectively drawn from the respective bobbins 3, 4, are inserted into respective through holes 51, 52 defined in an end face of a first die 5 that may be heated, e.g., to the softening temperature of the PP fibers 2 or higher, but preferably a temperature that does not exceed the processing temperature for the PP fibers (e.g., a temperature at which the PP fibers lose structural integrity and may break). The PP fibers 2 are inserted into the respective through holes 51 formed in a central portion of the end face of the first die 5, while the basalt fibers 1 are inserted into the respective through holes 52 formed in an outer peripheral portion of the end face of the first die 5. That is, the through holes 52 for receiving the basalt fibers 1 circumferentially surround the through holes 51 for receiving the PP fibers 1. Note that the numbers of the bobbins 3, 4 and the through holes 51, 52, i.e. the total number of basalt fibers 1 and the total number of PP fibers 2, may be appropriately selected in accordance with the particular specifications required for a particular reinforcing bar after molding. For example, and without limitation, four reinforcing (e.g., basalt) fibers and five or six thermoplastic (e.g., PP) fibers may be used in the present embodiment. In this embodiment and in any embodiments of the present teachings, each fiber of the reinforcing fiber and/or the thermoplastic fiber may contain a plurality of strands of the material either in a twisted form (i.e. a twisted fiber) or a non-twisted form (i.e. a tow). Each strand in the fibers may have a diameter of several to several tens of microns, e.g., 3-60 microns, e.g., 5-40 microns.

After the basalt fibers 1 and the PP fibers 2 pass through the respective through holes 51, 52 of the first die 5, they are collectively inserted into a single through hole 61 defined in the center of an end face of a second die 6 that is maintained at a predetermined temperature, for example, at a temperature exceeding the melting temperature of the PP fibers 2. While passing through the through hole 61, some of the melted polymer of the PP fibers 2, which have melted and fused with one another in the central portion of the cross-section, infiltrates (penetrates) between the basalt fibers 1 arranged in (circumferentially surrounding) an outer peripheral portion in the cross-section, thereby forming a primary bar 8 which is led out from the through hole 61 of the second die 6. Note that it is preferred that the through hole 61 gradually reduces in diameter (tapers) toward the outlet of the second die 6. In addition, it is also possible to provide a plurality of second dies 6, in which the through hole 61 of each second die 6 reduces in diameter (tapers) in the direction from the inlet to the outlet thereof, and the primary bar 8 is passed through all of the through holes 61 of these second dies 6 sequentially to impart a desired cross-sectional diameter and a desired cross-sectional shape to the primary bar 8. One or more of the second dies 6 also may be heated to the melting temperature of the PP fibers 2 or higher, or e.g., in a range between the softening temperature and the melting temperature of the PP fibers 2.

After exiting from the second die 6, the primary bar 8 is passed through a cooling device 7 in the final phase where the melted PP is hardened (solidified), and is then output as a reinforcing bar 9. FIG. 2 shows a notional cross-sectional view of the reinforcing bar 9. In the reinforcing bar 9, a bar-shaped (polymer) (resin) core 91 made only of the PP having a predetermined diameter is formed in the central portion of the cross-section, and the fiber-reinforced resin (polymer) layer 92 in which the basalt fibers 1 are embedded in the PP resin is formed in the outer peripheral portion surrounding the (polymer) resin core 91.

Because the reinforcing bar 9 having the aforementioned structure includes the bar-shaped (polymer) resin core 91 in the central portion of the cross-section and the fiber-reinforced (polymer) resin (polymer) layer (first sheath, shell, enclosure) 92 surrounding and integrated with the resin (polymer) core 91, the core 91 and the layer 92 are firmly bonded to each other to provide sufficient strength, and can be suitably used, e.g., for reinforcement of concrete. In addition, the method according to the present embodiment enables the configuration of the manufacturing apparatus to be simplified owing to the elimination of a storage tank for a molten resin solution as is required in conventional dipping methods and reduces manufacturing effort owing to elimination of providing (preparing) a resin bar as the core material in advance by extrusion molding or the like, whereby production costs overall can be reduced. It is noted that the core 91 may preferably have a diameter of at least 1.5 mm, or at least 1.7 mm or at least 2.0 mm, and may have a diameter that is 3.5 mm or less, or 3.2 mm or less or 3.0 mm or less. The range of diameters may be selected from any of the above-mentioned lower and upper limits. In the core 91 having such a diameter, none of the reinforcing fibers 1 are present. It is further noted that the layer 92 may preferably have a thickness (depth) of at least 0.75 mm, or at least 0.90 mm or at least 1.0 mm, and may have a thickness (depth) that is 1.75 mm or less, or 1.6 mm or less or 1.5 mm or less. The range of thicknesses (depths) may be selected from any of the above-mentioned lower and upper limits. In the layer 92 having such a thickness (depth), all of the reinforcing fibers 1 are present.

### Second Embodiment

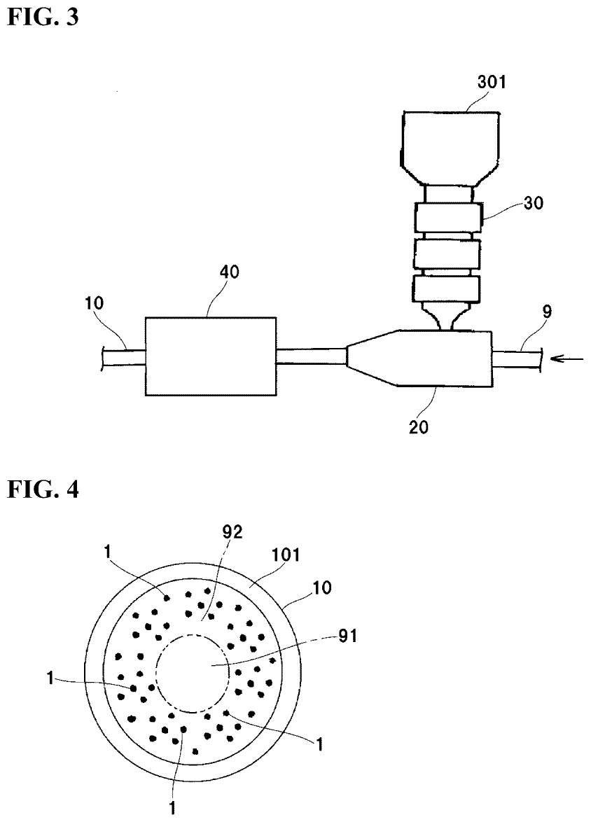

In another aspect of the present teachings, the reinforcing bar 9 produced by the method according to the first embodiment is supplied to an extrusion molding die 20 as shown in FIG. 3, to form a covering layer (second sheath) 101 having a predetermined thickness on (circumferentially surrounding) an outer periphery of the fiber-reinforced resin (polymer) core 92 as shown in FIG. 4. In other words, in FIG. 3: the reinforcing bar 9 produced by the method according to the first embodiment is supplied to an extrusion molding die 20. An extruder 30 provided with a hopper 301 for storing pellets of the thermoplastic polymer, e.g., PP pellets, is connected to the extrusion molding die 20. Molten PP is extruded onto the outer periphery of the fiber-reinforced resin (polymer) layer 92 of the reinforcing bar 9; and the molten PP thus extruded is hardened in the cooling device 40 in the latter phase to provide the covering layer 101. A reinforcing bar 10 having a covering layer 101 formed thereon can exhibit further increased strength and/or improved chemical resistance, due to the covering layer formed in a sufficient thickness. It is noted that the covering layer 101 may preferably have a thickness (depth) of at least 0.1 mm, or at least 0.2 mm or at least 0.3 mm, and may have a thickness (depth) that is 0.8 mm or less, or 0.7 mm or less or 0.6 mm or less. The range of thicknesses (depths) may be selected from any of the above-mentioned lower and upper limits. In the covering layer 101 having such a thickness (depth), none of the reinforcing fibers 1 are present.

### Other Embodiments

In the embodiments described above, polypropylene resin fibers were used as the thermoplastic resin fiber; however, the present invention is not limited thereto and polyethylene resin fibers or another type of thermoplastic polymer fiber may also or instead be used.

In addition or in the alternative, the reinforcing fibers are not limited basalt fibers and may also be selected from other non-metallic fibers, including inorganic fibers such as glass fibers (e.g., fiberglass) and carbon fibers (e.g., graphite fibers), or organic fibers such as aramid fibers and acrylic fibers.

The optional covering layer 101 is not required to be the same resin (polymer) as the fiber-reinforced resin (polymer) layer 92; however, using the same resin (polymer) is more advantageous for the purpose of integration (fusing) of the covering layer and the fiber-reinforced resin layer.

Optionally, the thermoplastic resin fiber and the reinforcing fiber may be twisted upon feeding into the die.

In the first embodiment, the first die 5 is configured to heat the PP fibers 2 to their softening temperature or above. In this regard, it is noted that the first die 5 preferably heats the fibers 1, 2 to a temperature that is lower than the melting temperature of the reinforcing (e.g., basalt) fibers 1 so that, throughout the manufacturing process, the reinforcing fibers 1 maintain their structural integrity and remain as intact (solid) fibers 1 that extend longitudinally in parallel to the longitudinal axis of the reinforcing bar 9 without ever melting.

In this regard, it is noted that one or both of the first die 5 and the second die 6 may be configured to heat the fibers 1, 2 to the temperature that is equal or greater than the softening or melting temperature of the thermoplastic fibers 2 and less than the melting temperature of the reinforcement fibers 1. In addition or in the alternative, it is possible to heat the first die 5 to a temperature lower than the melting temperature of the thermoplastic fibers 2 (or does not heat the fibers 1, 2 at all) so that the thermoplastic fibers 2 do not melt within the first die 5 and possibly break or drip. In such an embodiment, the second die 6 may be configured to heat the fibers 1, 2 to a temperature that is at or above the melting temperature of the thermoplastic fibers 2 so that the thermoplastic fibers 2 melt in the second die 6 and so that a portion of the melted thermoplastic infiltrates between the reinforcing fibers 1 while the fibers 1, 2 are disposed within (passing through) the second die 6.

The first die 5 and/or the second die 6 may include a heater than applies heat to the die 5, 6, e.g., by generating heat based on electrical resistance or by any other suitable heating method. The type of heater or heating configuration used to heat the first die 5 and/or the second die 6 is not particularly limited as long as one of the first die and/or the second die 6 can heat the fibers 1, 2 to a temperature that is equal or greater than the softening or melting temperature of the thermoplastic fibers 2 and less than the melting temperature of the reinforcement fibers 1.

The cooing device 7 also may be configured in various ways to perform the cooling function. For example and without limitation, the cooling device 7 may include liquid cooling pipes that surround and/or extend through the cooling device 7 and circulate a cooling liquid, e.g., water, antifreeze, etc., through the cooling device 7. In addition or in the alternative, the cooling device 7 may include a heat pump to remove heat from the cooling device 7, such as device having a compressor and an expander that generates cooling by compressing a refrigerant and then expanding the compressed refrigerant, whereby the cold refrigerant is fluidly communicated to the cooling device 7. In addition or in the alternative, the cooling device 7 may include a Peltier element that is configured to perform cooling when an electric current is supplied to the Peltier element. In the alternative, the cooling device 7 may be a cooling bath such that the primary bar 8 is simply immersed in the cooling bath (liquid) to cool and harden it.

Herein, the thermoplastic fibers preferably contain at least 50 mass % of a base polymer, such as the polypropylene or polyethylene. More preferably, the thermoplastic fibers preferably contain at least 90 mass % of the base polymer. The base polymer may be, e.g., a homopolymer, a copolymer or a multi-component polymer.

In the first and second embodiments described above, the reinforcing bar 9 has a smooth outer periphery that is circular in transverse cross-section. However, the reinforcing bar 9 may instead have a non-smooth outer periphery; e.g., one or more of bumps, ridges, grooves, deformations, etc. may be defined on the outer periphery. Any such structures may preferably have a depth or height from a circular cross-section of the outer periphery of at least 0.05 mm, at least 0.1 mm, or at least 0.15 mm, or 0.4 mm or less, 0.3 mm or less or 0.2 mm or less. In some embodiments of the present teachings, the linear thermal expansion coefficient of the reinforcing bar is preferably approximately equal to the linear thermal expansion coefficient of the concrete, in which it will be disposed, e.g., within +/−10% thereof. For example, the reinforcing bar 9 may have a linear thermal expansion coefficient in the range of 7-15×10⁻⁶/° C. The ultimate tensile strength of the reinforcing bar 9 is preferably at least 10 kN, more preferably at least 15 kN.

Each reinforcing fiber 2 preferably has a tex (grams per 1,000 meters) of about 4800, e.g., in the range of 3000-6000 tex, more preferably in the range of 4500-5200 tex. Each thermoplastic fiber 1 preferably has a dtex (grams per 10,000 meters) of about 15000, e.g., in the range of 13000-17000 dtex, more preferably in the range of 14000-16000 tex.

1. A method of producing a reinforcing bar comprising:
arranging at least one solid thermoplastic polymer fiber having a first melting temperature in a central portion of a cross-section;
arranging a plurality of non-metallic reinforcing fibers having a second melting temperature around an outer periphery of the at least one solid thermoplastic polymer fiber;
then heating the at least one solid thermoplastic polymer fiber to between the first and second melting temperatures to melt the at least one solid thermoplastic polymer fiber and form a melted thermoplastic polymer that infiltrates between, and bonds to, the non-metallic reinforcing fibers; and
cooling the melted thermoplastic to form a bar-shaped polymer core in the central portion of the cross-section and a fiber-reinforced polymer layer on an outer periphery of the bar-shaped polymer core.

2. The method according to claim 1, further comprising forming a polymer covering layer on an outer periphery of the fiber-reinforced polymer layer.

3. The method according to claim 1, wherein the non-metallic reinforcing fibers are basalt fibers.

4. The method according to claim 3, wherein:
the at least one solid thermoplastic polymer fiber comprises at least 50 mass % polypropylene or at least 50 mass % polyethylene; and
the bar-shaped polymer core contains no reinforcing fiber.

5. The method according to claim 4, wherein the reinforcing fibers are supplied so that the non-metallic reinforcing fibers entirely circumferentially surround the bar-shaped polymer and a longitudinal axis of each of the reinforcing fibers is parallel to a longitudinal direction of the bar-shaped polymer core.

6. The method according to claim 5, further comprising:
forming a covering layer that circumferentially surrounds an outer periphery of the fiber-reinforced polymer layer,
wherein the covering layer is composed of at least 50 mass % polypropylene and contains no reinforcing fibers.

7-9. (canceled)

10. The method according to claim 1, wherein the at least one solid thermoplastic polymer fiber comprises at least 50 mass % polypropylene or at least 50 mass % polyethylene.

11. The method according to claim 1, wherein the at least one solid thermoplastic polymer fiber comprises at least 90 mass % polypropylene.

12. The method according to claim 10, wherein the non-metallic reinforcing fibers are composed of at least one of basalt, glass, carbon, aramid and/or acrylic.

13. The method according to claim 11, wherein the non-metallic reinforcing fibers are composed of basalt.

14-20. (canceled)

21. The method according to claim 1, wherein the polymer core in the central portion of the cross-section fuses with the fiber-reinforced polymer layer during the step of cooling the melted thermoplastic.

22. The method according to claim 1, wherein the reinforcing fibers are supplied so that the non-metallic reinforcing fibers circumferentially surround the bar-shaped polymer and a longitudinal axis of each of the reinforcing fibers is parallel to a longitudinal direction of the bar-shaped polymer core.

23. The method according to claim 1, further comprising:
forming a covering layer that circumferentially surrounds an outer periphery of the fiber-reinforced polymer layer,
wherein the covering layer is composed of at least 50 mass % polypropylene and contains no reinforcing fibers.

24. The method according to claim 1, wherein the bar-shaped polymer core in the central portion of the cross-section has a diameter of at least 1.5 mm and contains no reinforcing fibers.

25. The method according to claim 24, wherein the non-metallic reinforcing fibers are basalt fibers.

26. The method according to claim 25, wherein the at least one solid thermoplastic polymer fiber comprises at least 50 mass % polypropylene or at least 50 mass % polyethylene.

27. The method according to claim 26, wherein the reinforcing fibers are supplied so that the non-metallic reinforcing fibers circumferentially surround the bar-shaped polymer and a longitudinal axis of each of the reinforcing fibers is parallel to a longitudinal direction of the bar-shaped polymer core.
